(19) United States
(12) Patent Application Publication
(10) Pub. No.: US 2010/0049974 A1
(43) Pub. Date: Feb. 25, 2010

(54) METHOD AND APPARATUS FOR VERIFICATION OF INFORMATION ACCESS IN ICT SYSTEMS HAVING MULTIPLE SECURITY DIMENSIONS AND MULTIPLE SECURITY LEVELS

(76) Inventors: Eli Winjum, Oslo (NO); Bjorn Kjetil Molmann, Lillestrom (NO)

Correspondence Address: KEVIN J. MCNEELY, ESQ., 5335 WISCONSON AVENUE, NW, SUITE 440, WASHINGTON, DC, 20015, US

(21) Appl. No.: 12/595,509

(22) PCT Filed: Apr. 15, 2008
(86) PCT No.: PCT/NO2008/000135

§ 371 Date: Oct. 10, 2009

(30) Foreign Application Priority Data
Apr. 16, 2007 (NO) 20071941

(51) Int. Cl. H04L 29/06

(52) U.S. Cl. 713/166

(57) ABSTRACT

We describe a model for multilevel information security. Information security is defined as combinations of confidentiality, integrity and availability. These three aspects are regarded as properties of a generic information object, and are treated as mutually independent. Each aspect is represented by an axis in an n-dimensional vector space, where n is the number of independent security aspects of interest. The model can ensure directed information flow along an arbitrary number of axes simultaneously. An information object is assigned a security label denoting the security level along an arbitrary number of axes. The model is role based. A role is assigned an access label along the same axes. Verification of a role's access to information is performed by comparing access label with security label. Since the aspects represented by each axis are mutually independent, each axis may be treated by itself. This enables a very efficient algorithm for verification of access. The model will therefore be suited for systems having low processing capacity. Based on this model, we describe a method and an apparatus to ensure confidentiality, integrity and availability for information from peripheral equipment in communications networks. Such peripheral equipment may be, but is not limited to personal terminals for rescue personnel, soldiers etc, sensors (detectors) for smoke, gases, motion, intrusion etc. The invention supports decision support systems in that the information has known confidentiality, integrity and availability even from inexpensive sensors, which do not include a processor or the like. The invention differs from prior art in that it, among other features: —Treats an arbitrary number of mutually independent aspects of information security, —Assumes that confidentiality, integrity and availability are mutually independent variables, —On this basis can verify access to information by means of simple binary operations, by a simple logic gate circuit or by a processor.

### 1 INTRODUCTION

Secure information systems differ in principle from other information systems in that it is easy to verify that they satisfy formal requirements for confidentiality, integrity and availability. Although known operating systems, database systems, routers and other common information and communications systems separate between users having different access, they partly have an access control, partly a plethora of different rights and roles, and partly missing functionality which make it difficult to verify that formal requirements for security are fulfilled.

Multilevel security (MLS) systems are secure information systems containing information from several security levels in one system. Such systems must handle information flow between the levels in addition to information flows into and out from the system. There are architectures where each system is dedicated to a specific security level. These are known as MSL-systems as in the English term Multiple Single Level or MILS as in Multiple Independent Levels of Security. MILS-systems do not inherently permit information flow between the security levels, and all information is handled as if it belongs to the highest security level. This description concerns a system having multiple security levels, not a MILS-system.

Increased use of information- and communications-technologies leads to an increased requirement for secure solutions. As indicated above, we use the usual definition of information security as a combination of confidentiality, integrity and availability.

Military systems have to a large degree focused on confidentiality, i.e. that information does not fall into wrong hands. Encryption, which ensures against unknown parties being able to read the information, gives an additional implicit integrity control for humanly readable information. If the receiver of a humanly readable message can read and understand a decrypted message, it is reasonable that the sender is the one he purports to be (he must at least have the correct key), and that nobody has tampered with the information in transit. Opposite, if the transmitted information is not humanly readable, or the receiver is a process in another computer, such implicit verification is impossible. If someone replaces the information in transit and the receiver decrypts trash, the result is still trash. To ensure data integrity, hash algorithms, not encryption, are employed.

Multilevel integrity systems are known from civilian applications, in particular financial businesses. As indicated above, modern information systems must be able to recognize if somebody has tampered with the information in transit when manual, implicit verification is no longer practical. In general, it is important to ensure that reliable information retains its reliability, about as for confidentiality. This requirement is far more general than the requirements for tracking and verification in a financial system.

Systems having multiple availability levels are becoming increasingly common in all areas where computers are used. For example, it may have lesser consequences for a business that the accounting office is unable to register vouchers for the next four hours, than that the web shop is down for a quarter of an hour. This requirement is independent of the requirements for reliability and tracking (integrity) of the two information systems, and independent of the confidentiality of the information in the systems. Today, the terms RTO (Recovery Time Objective—how fast can one get the system back on the air after a crash) and RPO (Recovery Point Objective—how much data can one afford to loose) are frequently used to classify the availability of systems. Common methods to ensure availability are redundant real time systems, e.g. RAID or hot standby servers to protect against physical faults, such as machine crashes and the like, and ‘old’ copies on tape, disk or as snapshots to protect against logical faults, such as accidental deletes, virus attacks or application errors. Because the price increases with the number of duplicated components and with the number of ‘old’ copies, it is inefficient to demand equal availability requirements for all systems.

Increased use of automatic transmission of systems information, e.g. SCSI blocks or routing information, thus implies that a modern multilevel security system must account for confidentiality, integrity and availability. Increased use of mobile information systems, e.g. laptops in wireless networks on arbitrary airports, equipment for rescue operations or military applications, sensor nets and the like pose additional requirements for effective methods to ensure security in systems having limited computing power and/or networks having low transmission capacities.

In the period 1975-1985 formal security models were developed to describe and analyze multilevel security systems. For example, a typical confidentiality modes shall guarantee that information cannot flow from a higher to a lower level of confidentiality, while information from a lower to a higher level of confidentiality shall be permitted. Formal multilevel security models have influenced present security regimes, especially confidentiality models governing military information systems. The models are based on closed mathematical structures, lattices, which provide secure event spaces provided that security levels, a flow operator and a join operator satisfy certain conditions. Even if such models are provably secure, they do not guarantee security if one or more conditions are not satisfied. Systems based on these models turned out to be expensive, complex and impractical. As a result, current practical security policies differ from the formal axioms.

Other disadvantages include overly restricted systems (too much information becomes too confidential) and cumbersome procedures for reclassification, which also may include guard functions. Even today, such functions may be based on manual revision and approval.

In spite of inherent difficulties, the cores of the classical models are still valid. We review the classical models for confidentiality and integrity in order to preserve the basic ideas. A corresponding classic model for availability is unknown to us, but we assume a metric may be defined which enforces different aspects of availability, defined as aspects of security that cannot be expressed as a combination of confidentiality and integrity.

As an alternative to the lattice models, we use n-dimensional spaces and simple operators. Here, we disclose a method to enforce multiple security aspects simultaneously. The method is effective, ensures information flow in correct directions along several axes simultaneously, and preserves the security levels. Verification of a subject's access to an information object according to the disclosed method requires a few clock cycles, or it may be implemented by inexpensive hardware, such as CMOS or NAND-circuits. This makes it possible to use the model within a broad specter of automatic information and communication applications, e.g. to secure operating systems, in mobile systems having extreme requirements for low resource consumption, in robust systems having multiple security systems where any attempted modification leads to the unit becoming physically destroyed, or for securing commercial applications in an easy verifiable way.

### 1.1 Definitions

Security policy defines what is, and what is not, allowed.
Security mechanisms are methods, tools or procedures enforcing a security policy.
Security labels are here elements containing control information describing the value of one or more attributes relevant for the security of a system resource, for example the security level of an information object in a multilevel system [1]. Security labels are most often used to support multilevel confidentiality policies, and may be a simple alternative to using cryptographic methods for keeping different levels apart. It is also known to use security labels to support integrity policies.

Information security is usually divided into three fundamental aspects: Confidentiality, integrity and availability. The following, is based on the definitions from [1], and describes the three aspects as properties of an information object.
Confidentiality is the property that data are not made known to system entities unless they are authorized to know the data [1]. A confidentiality policy therefore describes allowed data flow in a system, and aims at preventing information from being known to unauthorized.
Integrity is the property that data are trustworthy based upon the trustworthiness of the source, and which procedures are being used to handle data in the system. This encompasses the property that data are not altered, deleted or lost in an unauthorized way, or by accident. Integrity may also comprise the property that the information represented by the data is accurate and consistent. An integrity policy therefore concerns the trustworthiness of the data sources, that data values are not altered, that the data values are consistent, and may also concern the information represented by the values.
Availability is the property of a system or system resource that it is available, or usable or in operation on request from an authorized system entity according to the performance specification of the system. That is, a system is available if it provides services according to the specifications of the system when users ask for them. Aspects of availability may also include metrics for quality of service (QoS), priority, pre-emption, and general access rights to objects or certain database views. Several formal policy models are proposed for confidentiality and integrity. We do not know of any corresponding models for availability, but assume that availability requirements may be specified by quantitative metrics.

### 1.2 Assumptions

We assume there is a mechanism for access control enforcing a general access policy and regulates subjects access to objects based thereon. Our model regards access to information according to a multilevel security policy, and may be regarded as an addition to the regular mechanisms for access control.

Objects in our model use security labels use security labels to represent their security level, while subjects are assigned access labels. We assume that the verification per se, that the access label is controlled against the security label, is performed after the subject is authenticated as a legitimate entity, and after the access label is tested for data integrity.

Further, we leave to organizational procedures and authentication mechanisms to determine which persons are to be assigned which roles.

### 2 PRIOR ART

### 2.1 Security Models

The lattice properties allow precise formulation of the security requirements of an information system, and make it possible to construct mechanisms enforcing a security policy. Bell, LaPadula, Denning and Biba performed the basic research on lattice based access control during the seventies. Their research is summarized in [2].

A lattice model of secure information flows were proposed in [3]. The lattice structure reflects security classes corresponding to disjoint information classes, The security classes comprise, but are not limited to, the military security classifications. The author shows that a simple linear ordering of a set of security classes satisfies the lattice properties. A non-linear ordering of the classes leads to a more complex structure. The combination of linear and non-linear orderings further increases the complexity. The model exceeds the ordinary access control matrix in that it specifies secure information flow.

The Bell-LaPadula (BLP)-model describes a generic multilevel confidentiality policy [4]. The model has had crucial influence on military confidentiality policies. Subjects in the model have security clearance, while the objects are security classified. Security labels may indicate the different confidentiality levels, which in turn correspond to military classification levels. The system is secure if the set of state transitions maintain the following:
i. The simple security condition, which states that a subject can read an object if and only if confidentiality level_{subject}≧confidentiality level_{object}, and the subject has a discretionary read access to the object. This means that “reading down” is permitted, whereas “reading up” is disallowed.
ii. The *-property (star-property), which states that a subject can write an object if and only if confidentiality level_{subject}≦confidentiality level_{object}, and the subject has a discretionary write access to the object. This means that “writing up” is permitted, whereas “writing down” is disallowed.

The BLP model may be extended with categories, which are specified areas of interest. Thus, categories reflect a need-to-know-policy and regulates the subjects' access to information for which they otherwise are cleared.

Reference [5] criticizes and questions the proof for the BLP-model, and an alternative model for military message systems is proposed in [6]. The model introduces multilevel objects. The authors emphasizes that a security model should reflect application requirements, rather than the structure of operating systems.

The Biba-model describes a generic multilevel integrity policy [7]. The model stems from commercial business, where it has been particularly important to maintain data integrity. The model aims at preventing unauthorized modification of the information. The subjects and objects in the model have integrity levels which may be used as a measure of trustworthiness. A higher level implies more trustworthiness. Security labels may indicate the different integrity levels. The model itself forms the basis of a number of security policies. The most common is the strict integrity policy, which is the one associated with the Biba-model. The rules regulating read and write access are:
i. A subject can read an object if and only if integrity level_{subject}≦integrity level_{object}. This means that “reading up” is permitted, whereas “reading down” is disallowed.
ii. A subject can write (to) an object if and only if integrity level_{subject}≧integrity level_{object}. This means that “writing down” is permitted, whereas “writing up” is disallowed.

The Biba model is the dual of the BLP-model. If both models use identical security levels, the subjects may read and write objects if and only if level_{subject}=level_{object}. This contradicts a multilevel security policy.

A composite model is disclosed in [2]. The model uses independent confidentiality and integrity labels. The BLP-rules are used for confidentiality and the Biba-rules for integrity. The rules regulating read and write access are:
i. A subject can read an object if and only if confidentiality level_{subject}≧confidentiality level_{object} AND integrity level_{subject}≦integrity level_{object}.
ii. A subject can write (to) an object if and only if confidentiality level_{subject}≦confidentiality level_{object} AND integrity level_{subject}≧integrity level_{object},

The Lipner model extends the confidentiality classifications with integrity classifications [8]. The purpose of the model is to classify subjects and objects so that the subjects get access to the objects they need in order to do a job. A subject's rights to an object depends on both the confidentiality classification and the integrity classification. A classification comprises a security level as well as a compartment. A subject can read an object if and only if:
i. Confidentiality classification_{subject}≧confidentiality classification_{object}
ii. integrity classification_{subject}≦integrity classification_{object}

Another model referring to both confidentiality and integrity is the Chinese Wall model [9]. This model aims at enabling a policy regulating conflicts of interest in financial business. The model emphasize on sanitizing the objects, that is to remove sensitive data before information is released.

Well-formed transactions form the basic operations in the Clark-Wilson integrity model [10]. Data are consistent if certain properties are satisfied. Consistency conditions must hold before and after each transaction. The model separates data under integrity control from data that are not controlled. While the Biba- and Lipner-models simply assumes that a trusted entity upgrades the objects to higher integrity levels, the Clark-Wilson model introduces a set of methods which can be used to upgrade less trustworthy data to higher levels. The methods are certified by a trusted entity.

The requirements of the U.S. Department of Defence (DoD) has been the driving force behind a large part of the research on multilevel security. Requirements and adaptations are described in [11], [12] and [13]. The research has emphasized confidentiality, but a new work describing an architecture combining BLP and Biba is documented in [14]. The architecture thereby enables enforcement of access control based on both confidentiality and integrity.

A security model supporting dynamic relabeling is proposed in [15]. Rules for relabeling may be specified as part of the security policy. The model is of BLP-type, but may also support integrity policies.

Recent research on security models comprise the works presented in [16], [17], [18] and [19]. In order to separate reliable OS-processes from unreliable, [16] proposes to incorporate integrity levels in the BLP-model. [17] proposes a security model in which cryptographic functions are part of the OS kernel. The model concerns both confidentiality and integrity, but does not address multilevel security and information flow between levels. The model disclosed in [18] combines the BLP- and Biba-models, and extends the lattice representations with a weight operation. The model thereby enables weighting confidentiality versus integrity for subjects and objects. Another model based on both the BLP- and Biba-models is proposed in [19]. However, this model assumes that the level of confidentiality determines the level of integrity for subjects and objects. Security models for web based applications are evaluated in [20].

### 2.2. Security Labels

Internet Engineering Task Force (IETF) has attempted to standardize security labels for use in communication protocols. The security labels tell the communication protocol how data which are to be transmitted between systems shall be managed in order to maintain the security level. Operating systems and database management systems label data according to local security policy and local format. Communication protocols require standards in order to translate this to proper protection during transmissions. During the eighties, U.S. Security Options for the Internet Protocol was specified [21]. The specification identifies and describes the different classification levels supported during transmission of an IP datagram. The specification also describes which authorities' policies are used. A few years later, the Security Label Framework for the Internet was specified [22]. Confidentiality as well as integrity labels are included. The framework treats each of the seven communication layers in the OSI-model.

We also mention an architecture aiming at security labeling XML as well as non-XML formatted information for use in networks of military MSL-systems [23]. This architecture, however, only addresses humanly readable information.

### 2.2 Role Based Access Control

Research on role based access control (RBAC) may also be tracked back to the early seventies. Access is based on the roles individual users have as part of an organization. The roles are based on analysis of the organization. A purpose of RBAC is to provide separation of duties in order to reduce the risk for fraud.

A framework of reference models to manage the components in RBAC is disclosed in [24]. The authors claim that RBAC is policy neutral, which is confirmed by [25]. This work shows that RBAC can support lattice based security models for confidentiality and integrity. The objects in lattice based models have one single security label, whereas the authors recommend that read- and write access are assigned to separate read and write roles.

A National Institute of Standards and Technology (NIST) standard for RBAC is proposed in [26]. In order to manage dynamic aspects, the addition Temporal RBAC is proposed in [27].

### 3 INDEPENDENT SECURITY DIMENSIONS

The one who knows everything can say nothing. The one who knows nothing can say everything.

### 3.1 Role Based Access Control Revisited

Traditionally, subjects have been defined as active objects. In order to avoid confusion, we prefer avoiding the term ‘subject’ in the following. We regard confidentiality, integrity and availability as properties of information, and access to the information a property of a role.

A ‘role’ may, for example, be an aspect of a computer process, a user account or of a person. This works as in the real world. A person may have access to information in her or his role as an authorized professional, but not in her or his role as a parent, friend or the like.

Here, roles are characterized by their access to information. A role having access to secret information does not need to be secret. A role cleared for a low level of integrity can simply read from all integrity levels. The role says nothing about a person's personal integrity. Similar arguments can be made for the availability properties.

Further, we separate between read and write access only, and note that create, delete/drop and execute operations can be regarded as write operations in another context. A more detailed description may be found in [2].

### 3.2 Confidentiality

A well known example of confidentiality levels are the levels Unrestricted, Restricted, Confidential and Secret used in military and governmental applications. More levels, such as Top Secret or Nato-levels obviously may be added if needed. Similar confidentiality levels are also used in civilian applications to prevent information important to business operations from being disclosed. Every level may have its own requirements for encryption, key management and other security mechanisms. The number of confidentiality levels and specific rules vary between countries and between organizations.

We define generic confidentiality levels as a finite set of k levels {λ₁, λ₂, . . . λₖ} where k is an integer, and a higher index or level means higher confidentiality. Further, we require the confidentiality levels and the information in them to satisfy the fundamental rules of the BLP-model. In short:
C 1. Confidentiality flow operations
C 1.1 Information must not flow from a higher to a lower level of confidentiality
C 1.2 Information may flow from a lower to a higher level of confidentiality
C 2. Confidentiality join operation
C 2.1 If information elements from two confidentiality levels are combined, the combined information shall be assigned the higher of the two confidentiality levels.

It is possible to assign a confidentiality label L_{C} to the information, for example as an attribute in any object oriented language or in a relational database. In the same way, it is possible to assign an access label M_{C} to a role.

A role may read information from confidentiality levels at or below its clearance level, and write information to confidentiality levels at or above its clearance level. Both accesses may be controlled by comparing the clearance level, represented by M_{C}, with the information's confidentiality label L_{C}. The confidentiality join operation implies that when information from two confidentiality levels are combined, the result is assigned the confidentiality label representing the higher of the two confidentiality levels.

### 3.3 Integrity

Assume we have two pieces of intelligence information. One is a rumor, whereas the other is verified by several independent and reliable sources. These information pieces may be assigned two integrity levels, but still be equally confidential.

We use the notation from [2] and define generic integrity levels as a (finite) hierarchy of m levels {ω₁, ω₂, . . . ωₘ} where m is an integer, and a higher index or level means higher integrity. Further, we require the integrity levels to satisfy the fundamental rules of the Biba-model. These are ‘the opposite of’ (dual to) the BLP-rules for confidentiality:
I 1. Integrity flow operations
I 1.1 Information must not flow from a lower to a higher level of integrity
I 1.2 Information may flow from a higher to a lower level of integrity
I 2. Integrity join operation
I 2.1 If information elements from two integrity levels are combined, the combined information shall be assigned the lower of the two integrity levels.

A trivial situation arises if we represent confidentiality- and integrity levels on the same axis. If we move a security level along that common axis, we have to break the rules for either confidentiality flow or integrity flow. This holds regardless if we see the integrity levels as sub-levels of the confidentiality levels or vice versa. The problem may obviously be avoided by letting higher integrity levels represent lower integrity, and add rules separating main-levels from sub-levels. Reference [2] discloses lattice-based security classes designed to preserve confidentiality as well as integrity without ending up in this trivial situation.

Many of the problems of complex set of rules for security classes combining confidentiality and integrity appears to be due, in part, to that confidentiality and integrity has been regarded as partly interdependent, and, in part, that they form a (Cartesian) product of (partly) linearly independent variables, for example all integrity levels as sub-levels of the confidentiality levels or vice versa.

We emphasize that we treat confidentiality and integrity as (linearly) independent variables, and that this is a necessary and sufficient condition to treat them separately, rather than as a (Cartesian) product. We note that linear independence is no limitation, as apparent ‘dependencies’ between confidentiality and integrity simply may be described as a linear combination of them.

Integrity can now be represented by an integrity label, L_{I}, assigned to the information. As for confidentiality, we can test the role's access label for integrity, M_{I}, against the label L_{I} of the information. A role may read information from integrity levels at or above its clearance level, and write information to integrity levels at or below its clearance level. A combination of information from two integrity levels is assigned the integrity label representing the lower of the two integrity levels.

Testing if a role may read or write now means:
Can read=((can read confidentiality level) AND (can read integrity level))
Can write=((can write confidentiality level) AND (can write integrity level))
   where reading or writing levels of confidentiality or integrity just involves simple tests of the role's access labels (clearance levels) M_{C} and M_{I} against the respective labels L_{C} and L_{I} of the information.

### 3.4 Availability

In the introduction, we mentioned that availability may be seen as a function of RTO and RPO, and showed that such availability is independent of confidentiality and integrity.

In communication applications, one availability policy can regulate a subject's access to a certain quality of service (QoS). In other contexts, an availability policy may regulate the subject's right to priority. Both are independent of confidentiality and integrity.

The term availability thus has different meanings in different systems. Moreover, we see that several systems may possess different aspects of availability. In order to avoid Cartesian products and complex sets of rules, it is also in this area necessary and sufficient that ‘availability’ is linearly independent of confidentiality and integrity. Hence, we simply define:
A 1. Availability is any security related property which cannot be expressed as a (linear) combination of confidentiality and integrity.

This definition ensures completeness, and emphasizes that confidentiality and integrity are not the only properties limiting access to information.

Fra A 1 follows that a complete security space may be spanned by ordered n-tuples S=[λᵢ, ωⱼ, γ_{1,k} . . . γ_{n-2,m], where λ}ᵢ, and ωⱼ, represent confidentiality and integrity dimensions as above, and γ₁ . . . γₙ₋₂, represent mutually independent variables or axes, which each may have a different number of levels, e.g. the integers k or m. A major point is that the only condition for regarding the axes one by one (as opposed to weakly defined Cartesian products) is that the axes denote mutually independent properties, i.e. that they are mutually independent variables. For the sake of clarity, we note that the confidentiality and integrity axes also may be split.

The availability labels may be different from the confidentiality and integrity labels in that an exact match between a security label, L_{A}, and an access label, M_{A}, may be required. In other applications, the availability levels may form a hierarchy. Assume, for example, a communication channel where high-priority traffic shall be transmitted before low-priority traffic. This may be modeled by the type of access labels used for confidentiality when high priority means “high level”, or as for integrity when “first priority” represents the highest priority.

### 3.5 Security Dimensions and Planes

Our model levels information along n dimensions. Hence it describes a security policy regulating multiple aspects of security. The basic dimensions are confidentiality, integrity and availability. As described above, each of these may be split into several axes.

The basic dimensions span three planes: Confidentiality—Integrity (CI), Confidentiality—Availability (CA) and Integrity—Availability (IA).
The CI-plane may be exemplified by military intelligence information. Levels of integrity may separate information which is based on rumors and non-verified observations from verified information. An access mark of each process enables controlled use of information from the different levels. Levels of confidentiality may separate secret information from public information. These levels are independent of the integrity levels.
The CA plane can be related to traditional military security models, in which subjects are cleared for specific confidentiality levels and categories, which reflects the need-to-know principle: A subject may be cleared for information at a specific confidentiality level. In addition, the subject must be authorized for specific categories. The categories may comprise information belonging to different nations or constellations of nations, for example, US, US-UK, UK-FR. As mentioned in chapter 2, confidentiality levels and categories may be modeled as a lattice. However, a category may be regarded as an aspect of availability. Hence, we propose to represent the levels along the confidentiality axis, and categories along the availability axis. Thus, the CA-plane expresses a role's access rights as in a traditional military confidentiality policy.
The IA-plane may be exemplified by asynchronous replication to a disaster recovery site. An application can contain logs in RAM which are written to disk at certain points in time (time marks). The interval between these time marks defines the maximum amount of data which may be lost, i.e. the recovery point objective (RPO). Once data are written to disk, all the SCSI-blocks that are altered since the previous time mark are hashed and sent to another location, often over a WAN. The hash-function ensures integrity, i.e. that all SCSI-blocks are received and no unauthorized modification of data in transit has occurred. Note that encryption would not have ensured integrity: A decrypted block of trash cannot not as a rule be distinguished from a decrypted block of valid data.

A policy based management system may read the availability label of an application. The availability level may represent the maximum amount of time an application is allowed to be unavailable, the recovery time objective, (RTO). It may alternatively show the RPO of the application in order to determine the interval between time marks. This may be, but is not required to be, constant. The level of integrity may determine which hash-algorithm is to be used during replication.

### 3.6 Automatic Verification

In systems involving humans, confidentiality mechanisms may implicitly verify integrity. Controlling that a decrypted message is readable by humans imply, for example, that sender and receiver use the same encryption algorithm and the same encryption key. This may authenticate the sender, and verify that the message is not modified by unauthorized parties.

In automatic systems, one has to recognize the fact that confidentiality and integrity are independent variables. A number of SCSI-blocks transferred from A to B cannot easily be verified by a human at B. In such cases, a hash function is usually employed to detect unauthorized modifications, and possibly to provide a signature authenticating the sender. The blocks may, of course, also be encrypted in order to ensure confidentiality.

### 4 TESTING ALL DIMENSIONS WITH A MINIMAL USE OF RESOURCES

### 4.1 Security Labels and Access Labels

Let L denote a security label assigned to an information object, and M denote a corresponding access mark assigned to a role in order to allow or deny access to the information object. Indices C, I and A denotes confidentiality, integrity and availability respectively when needed. For the operators, we use the notation & (bitwise AND); |(bitwise OR); && (logical AND).

One possibility is to let L_{C}, L_{I} and L_{A} be arbitrary numerical values such that a higher number in L_{C} means a higher level of confidentiality, and a higher number in L_{I} means a higher level of integrity. By assigning corresponding numbers M_{C}, M_{I} and M_{A} to a role, testing for read access to confidentiality classes is reduced to testing the expression L_{C}≦M_{C}. Similar tests can be performed for writing to confidentiality class (L_{C}≧M_{C}), reading from integrity class (L_{I}≧M_{I}) and writing to integrity class (L_{I}≦M_{I}). Using this method, it is possible to represent 2^{k} levels by k bits.

Another possibility is using access masks and logical operators to perform similar tests. This method implies that at most k levels may be represented by k bits, but also that all partial tests in the n-dimensional security space spanned by the confidentiality, integrity and availability axes may be performed by one single bitwise AND. The method also permits using Hamming-vectors in the security labels, which may be beneficial in some applications.

In both cases, partial tests for confidentiality, integrity and availability must be followed by logical AND operations on the Boolean results of all n partial tests. For n=3, for example, the following is valid:
Access=(L_{C}&M_{C}) && (L_{I}&M_{I}) && (L_{A}&M_{A})

Different read- and write masks may be assigned to read- and write roles such that read-roles test read access and write-roles test write access. We repeat that it is trivial to split for example availability into several mutually independent dimensions.

As a non-limiting example, assume a bitfield having 4 bits and the confidentiality classes {Unrestricted, Restricted, Confidential, Secret}. The confidentiality classes Unrestricted, Restricted, etc can be represented by four bits where all are 0, except a 1-bit which is shifted left 1 position for each higher level. This is illustrated in table 1.

TABLE 1
Effects of bitwise AND between confidentiality
labels and an access mask.

| | Confidentiality of information | | | |
|---|---|---|---|---|
| | Unrestricted | Restricted | Confidential | Secret |
| Confidentiality label | 0001 | 0010 | 0100 | 1000 |
| L_{C} | | | | |
| Role's access label M_{C} | 0011 | 0011 | 0011 | 0011 |
| L_{C} & M_{C} | 0001 | 0010 | 0000 | 0000 |
| Boolean value B_{C} | TRUE | TRUE | FALSE | FALSE |

The last row utilizes the fact that value 0 becomes Boolean FALSE, whereas all other values become Boolean TRUE.

From Table 1, it is clear that the access label in the form of an access mask 0011 allows access to the two lowest levels, and thus may be used for permitting read access to confidentiality classes.

In order to implement flow between confidentiality classes, we define separate and mutually exclusive read and write roles, having the following access labels in the form of access masks:
Confidentiality, read: 0 or more 0's, followed by 0 or more 1's e.g. 0011 or 1111
Confidentiality, write: 0 or more 1's followed by 0 or more 0's, e.g. 1100 or 1111

When higher valued integrity labels L_{I} represent more integrity, the corresponding access masks to implement permitted information flow between integrity levels become:
Integrity, read: 0 or more 1's followed by 0 or more 0's, e.g. 1100 or 1111
Integrity, write: 0 or more 0's, followed by 0 or more 1's e.g. 0011 or 0000

We could, of course, have changed the usual order, and let a higher integrity level represent lower integrity. However, this would differ from usual practice, and hence easily be misunderstood.

When information from different confidentiality and integrity levels under the assumptions above are combined, the following rules apply:
A combination of information from two confidentiality levels is assigned the confidentiality label L_{C} representing the higher confidentiality level.
A combination of information from two integrity levels is assigned the integrity label L_{I} representing the lower integrity level.

Not all bit-combinations are equally useful in the security labels of such a method. Consider, for example, two confidentiality labels L_{C1}=0100=2²=4 and L_{C2}=0101=2²+2⁰=5. If all possible 4-bit combinations were allowed, L_{C2}=5 could be regarded as representing a higher confidentiality level than L_{C1}=4. But L_{C2}& M_{C}=TRUE. By allowing all possible values in L_{C}, we thus introduce a need for a table of which marks represent which levels, and the bitwise AND operation becomes pointless.

We have shown that values consisting of one 1 which is shifted left 1 position per level, and otherwise 0's, give the required effect, and note that this is not the only possibility. For example, a longer security label comprising 4 different 4-bit subfields and an access mask created by adding fields having 4 0's or 4 1's also may be used. This is illustrated in Table 2.

TABLE 2
More general security labels and access masks

| | Binary | Hexadecimal |
|---|---|---|
| Security label (L) | 1001 0101 1010 0110 | 9 5 a 6 |
| Access label (M) | 0000 0000 1111 1111 | 0 0 f f |
| Bitwise AND (L&M) | 0000 0000 1010 0110 | 0 0 a 6 |

Table 2 illustrates that a more general security label for confidentiality or integrity may comprise several subfields. It is to be understood that the subfields does not have to be 4 bits long. It is not even necessary that all subfields have equal length. A valid access mask need only consist of correspondingly long subfields having only 0's to refuse access or only 1's to allow access.

Now it is readily seen that the maximum number of permitted levels using this method and security labels having k bits is k. This happens when all subfields are one bit long.

Let us have a closer look at a security label for confidentiality and integrity where, for example, the first 4 bits represent confidentiality and the next 4 bits represent integrity.

| | |
|---|---|
| Security label: | 0100 0100 |
| Access mark for reading: | 0011 1100 |
| Bitwise AND: | 0000 0100 |

In this example, the first 4 bits evaluates to 0. That is, read access shall be denied because the role is not cleared for the confidentiality level represented by the label 0100. The fact that the integrity field, and hence the entire byte, becomes non-zero, or Boolean TRUE, cannot permit read access. Therefore, it is important to test each of confidentiality and integrity first, and thereafter combine the partial results in a logical AND in order to obtain the desired result.

We have shown above that the security labels representing confidentiality, integrity and availability are separate, and that they must be treated independently of each other.

The fact that they are independent of each other, also simplifies the verification of the system. Rather than verifying that a complex set of rules in no way can lead to implicit level transitions, or enter an undefined state, it is sufficient to verify that flows between different confidentiality and integrity levels are secure each by it self, and that the availability classes work properly, depending on application, and independent of confidentiality and integrity.

As shown above, flow control along the confidentiality and integrity axes can be enforced by constructing suitable security labels and access labels in the form of access masks, and thereafter perform one bitwise AND. It is easy to demonstrate that the proposed security labels, access labels and operators implement a lattice as described in [3]. A corresponding bitwise AND may be performed on the availability axis. In some instances, it may be practical to require an exact match between the security label L_{A} and the access mask M_{A}. In other instances, it will be required to implement a flow control. Both can be achieved by constructing suitable L_{A} and M_{A} and testing L_{A}&M_{A}.

In some instances, for example secure light-weight applications or computer programs, the mutually independent security labels can be placed non-overlapping in one 32 b or 64 b data word. This also applies to the availability axes in the form of access labels. In general, such a combined security label may consist of a data word of word length bits, in which the first k bits represent confidentiality, the next m integrity, and the last n=(word length−k−m) represent availability.

In applications wherein different roles manage confidentiality, integrity and availability, it may be practical to pad their access labels with all 0's such that all masks become word length bits long. M_{C} would then mask away everything but L_{C}, M_{I} would mask away everything but L_{I} and M_{A} would mask away everything but L_{A}.

In other applications, it may be more practical to combine these three with a bitwise OR. In this case, exactly one bitwise AND between the word containing the security labels and the word containing the access marks is all that is needed to perform all partial tests for confidentiality, integrity and availability. Thereafter, a few further clock cycles are required to perform the logical AND-operations between the independent test results.

### 4.2 The Dispatcher-Function

Assume that security labels of the type described over are attributes in a generic information object, for example implemented as attributes in a class in an object oriented language or as attributes (column(s)) in tables within a relational database.

Further, assume that the security labels are already employed to determine priority and/or authorization, such that an authenticated and authorized user has read access to confidentiality level (C-level)≦λᵢ and integrity level (I-level)≧ωⱼ.

In such a case, a process in the server, the Dispatcher, can run through all security labels, and display only information having C≦λᵢ and I≧ωⱼ. In order to do this, the Dispatcher needs access to the security labels. The Dispatcher does not need to be able to decrypt or modify anything, but it must be able to read the information in order to forward it, e.g. in encrypted format if the information is stored in encrypted format.

The receiver may equally well be a process as a human user. The Dispatcher may also be a process in a system different from an application server, for example in a multilevel router. The security labels for availability may also be used for other purposes than authorization.

In general, the Dispatcher requires:
A read-role cleared for highest confidentiality and lowest integrity to be able to read everything,
A write-role cleared for lowest confidentiality and highest integrity to be able to write everything, and
Further properties required by the application for availability.

The Dispatcher may optionally show or conceal that there is information in the system unavailable for the user, if it knows the access label of the user.

### 4.3 Alternative Equivalent Labels

L≧M [symbol] M≧L and L&M=M&L This shows that the security labels L and access labels M are interchangeable. This also models the real world. For example, a sensor in a sensor network can be assigned a write role, and (hardwired) M-masks for confidentiality, integrity and availability. Incoming signal for a passive sensor would then be a security label L. Because it must be possible to alter the security label L in confidentiality and integrity class combinations (joins), it is impractical to hardwire L. A fixed M and variable L is more practical in this application, even if the sensor intuitively just as well could have been regarded as an ‘information object’ having a security label L. Thus, the contents of the marks L and M is arbitrary insofar as one of them represents a level, and the other represents an access right to that level.

### 5 SOME APPLICATIONS OF THE MODEL

### 5.1 Web Services

Web servers are usually applications generating different XML or HTML documents depending on the role of the client side. These documents are usually read and presented by client processes, for example web browsers presenting information understandable to humans in the form of text, pictures or sound. Usually, anonymous users are allowed to view some web pages, “logged in” (authenticated and authorized) may get read access to more web pages, and an editor role may be allowed to create, edit and delete pages. Here, it does not matter if the role on the client side is assigned to a human or a process. In secure applications, the point is that information shall be presented only to roles authorized for the confidentiality, integrity and availability levels of the information. Obviously, it is simpler and more secure that the server send, or does not send, information based on the client sides authorization, than leaving the client side to filter out the information to which the client has valid access. Our model will support such applications independent of formats and protocols involved in the communication between server and client. We note in particular that the model eliminates requirements for (heavy) encryption for implicit integrity control of messages (e.g. text based XML or SOAP documents), and enables new, secure services based on availability aspects, as well as simplifications and services based on combinations of different security axes.

### 5.2 Multi-Level Routing

We assume the security label is associated with a set of security services like encryption and authentication. These will be used when information is transmitted over a communications network to ensure that the security levels are maintained during the transmission. In order to protect the IP-network itself, an additional requirement may be that the routing information must be secured. In some scenarios, the routing information should be assigned different integrity levels. In other scenarios, it may be important to conceal parts of the network topology. Then, assigning different levels of confidentiality to the routing information may be a requirement. Multilevel routing may be implemented by calculating routing tables for different levels of security. Our model will support multilevel routing.

### 5.3 More Secure Systems

By using security labels on memory locations, registers etc, the robustness against security errors and intrusion, for example virus attacks, is improved. It is also possible to hardwire registers that cannot be modified without the unit being physically destroyed. By using security labels on database objects and controlling the information flow within computer programs, the security is enhanced. Such control may be performed by compilators or at runtime. Our model for verification of security labels may perform this control in a very efficient manner. Security and access labels can be represented in a more robust manner by using Hamming-vectors. The system security may be further enhanced by incorporating secure functions for authorized reclassification of objects.

### 6 TECHNICAL DESCRIPTION OF THE INVENTION

### 6.1 Secure Lightweight Applications

In some applications, e.g. sensor networks in which the sensors are distributed ‘arbitrarily’ in a terrain or provided more permanently in a building, it may be a requirement that the sensors may not be tampered with out being destroyed. This may, for example, be achieved by soldering or surface mounting digital circuits on a conventional card. Such equipment becomes more robust against attacks, unauthorized modifications etc, and it achieves longer battery lifetimes and cost less than equipment having an integrated microprocessor.

By providing digital registers representing the bit patterns in the above L and M labels respectively, and compare them using known digital techniques, we can achieve verifiable information flow between several security levels and along several security axes concurrently, without the use of microprocessors or computer programs.

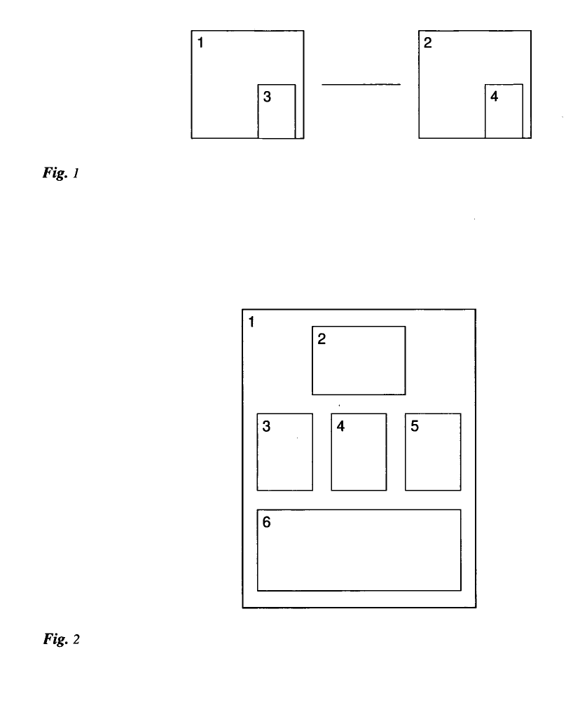

FIG. 1 shows two generic terminal devices 1 and 2 for secure applications, in which security labels and/or access labels according to the invention is provided in a removable unit (3 and 4) inserted into the terminal device. Other information related to security, such as keys or certificates, may also be provided on the removable units 3 or 4. Such a generic terminal device (1 or 2) may, for example, comprise, but is not limited to, personal communications equipment for use by personnel in rescue operations or soldiers. The removable unit to be inserted into the terminal device may be, but is not limited to, e.g. SIM-cards as in a cellular or mobile telephone, smartcards or PCMCIA-cards in PDAs, laptops, desktop machines or servers, or as files or programs in ROM. Such equipment, and the use of it, is in and by itself known to a person skilled in the art, and does not constitute a part of the invention.

Communication between the terminals will as a rule occur in ways well known to anyone skilled in the art, e.g. over wireless (radio) networks, wires, buses etc using well known signalling methods and protocols like 8-bit phase shift keying, IP, SCSI or something else.

It is new that security and/or access labels provided on physical equipment like smartcards or digital print boards without microprocessors concurrently handle multiple security dimensions and information flow in a multilevel system. This may render it impossible to modify the labels without destroying them physically, and at the same time facilitate verification of the security levels because there is no way to alter the labels using instructions in a (micro)processor.

Thus, the invention makes it possible to provide networks and applications in which even the most peripheral units support correct information flows along multiple axes and different security levels concurrently. When the confidentiality and integrity of information is documented and verifiable, the use of it in automatic decision support systems may be simplified.

FIG. 2 illustrates a terminal 1 having a receiving and authentication device 2, which places an incoming signal in registers L within a register unit 3, 4, 5. The number of register units may be any integer between 1 and n, and does not have to be 3. By comparing the L-registers in the register units 3, 4, 5 with corresponding physical M-registers, a digital gate circuit may set a digital output signal high or low depending on the pre-assigned security label or access label of the terminal device and the incoming access label or security label. The digital output signal can, but is not limited to, be used to control a transmitter which transmits data from an information source 6. This may be done in a known manner, for example by connecting the output signal to the base of a transistor to provide current to a transmitter circuit when the output signal is high, and provide no current when the output signal is low.

The information source may be, but is not limited to, a (passive) sensor which is to be polled in a secure manner, an (active) sensor writing to all security permissible levels when it detects e.g. smoke or hazardous gases, and which may become priority in the network based on its availability label, a communication device in mobile or stationary equipment, et cetera.

It is to be understood that a security label may be placed in one of two registers L or M provided an access label is placed in the other. The result of a bitwise AND between the two registers is independent of whether the security label is placed in the L or M register. Thus, it is to be understood that the incoming signal may represent either a security label or an access label. It is also to be understood that the invention may be used in a transmitting unit in a similar manner, even if this is not shown in the drawings. Moreover, the transmitting device may be adapted to transmit a signal representing a security label or access label according to the invention in a similar manner as the illustrated receiving device is adapted to receive a signal in the registers L within the register units 3, 4, 5.

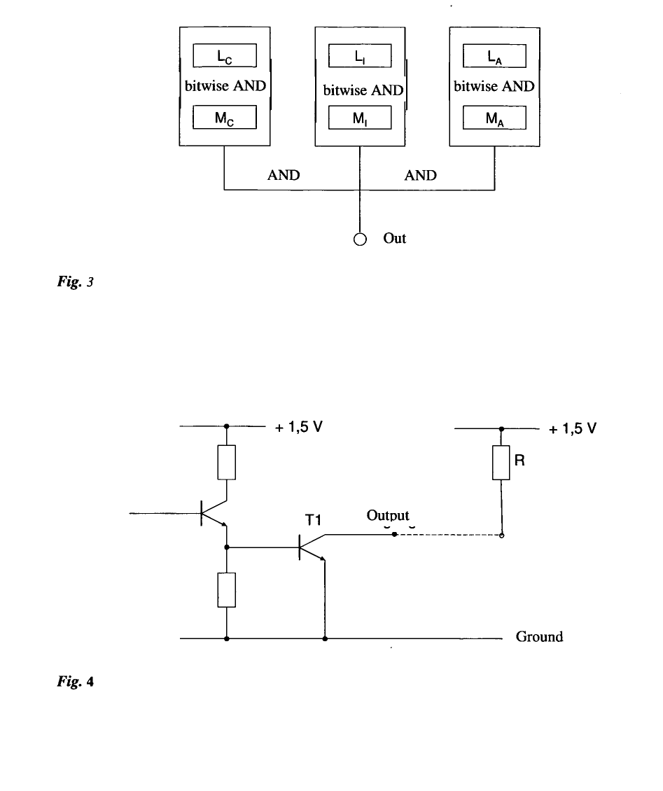

FIG. 3 is a detailed view of the register units 3, 4, 5 of FIG. 2. An incoming signal is placed in the independent registers L_{C}, L_{I} and L_{A} in a known manner. Registers M_{C}, M_{I} and M_{A} represent complementary labels which by bitwise AND operations regulate access along three independent axes C (confidentiality), I (integrity) and A (availability), maintains mandatory permissible information flow along the axes C and I, and, if desired, information flow along the A-axis.

The results from each independent register, which may be less than or more than 3, are combined by logical AND-operations in order to provide an output signal, which, for example, may be used to indicate whether transmission of data from an information source is permitted or not from a security perspective. In this case, the output signal can easily be employed to activate or deactivate a transmitter circuit as described in conjunction with FIG. 2.

FIG. 4 is fetched from a textbook from 1980 [28], and shows a typical open collector circuit, frequently called “hardwired OR”, used in logical circuits. For this circuit to provide a logical output level, the output must be externally connected to the positive supply voltage (+1.5V) over a resistor R. The resistor R will be common to all outputs on the line. T1 may represent a first transistor connected to bit 1 of register L, and T2 a similar transistor connected to register bit 1 of register M. If all these circuits have a high ENABLE signal, the circuits will represent a bitwise OR between the bit values from the registers connected to T1 and T2 respectively. Equivalent circuits may be made from scratch, or be provided as commercially available integrated logic gate circuits, e.g. as NOT-AND (NAND) circuits. Such logic gate circuits may be used to obtain the partial results by performing bitwise ANDs between the register values, and also logical ANDs between the partial results in order to provide the desired output signal. We do not pretend that this is new.

It is also well known for persons skilled in the art of digital circuits how De Morgans laws NOT (A AND B)=(A OR B) and NOT(A OR B)=(A AND B) are employed to implement logical operators by logic gate circuits as the said OR=NAND circuits. We note for the sake of precision that +1.5V is shown on FIG. 4 because this is a standard battery voltage, but that another voltage equally well might be used.

Finally, we note that the invention may employ, but does not depend on, for example, logical TrL circuits. In TTL-gates, typical values for output current capacity are I_{OH}=−400 μA (where the minus sign only means that the current leaves the gate), and required input current for logical HIGH I_{IH}=40 μA, while output current capacity for logical LOW may be I_{OL}=−16 mA and input current I_{IL}=1.6 mA. Fanout is the lower of the two fractions I_{OH}/I_{IH} and I_{OL}/I_{IL}, and determines how many input gates may be driven from one output gate (typically 10 for TTL). It is well known to a person skilled in the art how such gates are cascaded to implement more than 10 logical operators. The numbers are mainly provided in order to illustrate that the power consumption does not need to be large in order to implement the invention. This helps to prolong the lifetime of batteries relative to prior art.

The invention may employ (hardwired) register values in logical digital circuits for use in secure applications to provide proven and simply verifiable secure devices, which cannot be modified without being destroyed.

By arranging register values as disclosed in chapter 4 above in logical circuits as described here, or in equivalent physical equipment, an invention according to the claims may be used in ICT-systems which are secure in multiple security dimensions in information systems having multiple security levels, and which ensures secure information flow along one or more security axes when required. We note also that all tests may be performed in a time in the order of the rising time of a transistor without the use of software or processors.

### REFERENCES

[1] R. W. Shirey, “Internet Security Glossary”, Internet Engineering Task Force (IETF) rfc2828, 2000.
[2] R. S. Sandhu, “Lattice-Based Access Control Models”, IEEE Computer, vol. 26, no. 11, 1993, pp. 9-19.
[3] D. E. Denning, “A Lattice Model of Secure Information Flow”, Communications of the ACM, vol. 19, no. 5, 1976, pp. 236-243.
[4] D. E. Bell and L. J. LaPadula, “Secure Computer Systems, Mathematical Foundations”, Mitre Corp. Report No. MTR-2547, Bedford, Mass., USA, 1975.
[5] McLean, “A Comment on the “Basic Security Theorem” of Bell and LaPadula”, Information Processing Letters, 20, 1985, pp. 67-70.
[6] C. E. Landwehr, C. L. Heitmeyer and J. D. McLean, “A Security Model for Military Message Systems”, ACM Transactions on Computer Systems, vol. 2, No. 3, 1984, pp. 198⁻²²².
[7] K. J. Biba, “Integrity Considerations for Security Systems”, Mitre Corp. Report No. MTR-3153, Bedford, Mass., USA, 1977.
[8] S. B. Lipner, Non-Discretionary Controls for Commercial Applications”, Proceedings of the 1982 IEEE Symposium on Security and Privacy, 1982, pp. 2-10.
[9] D. Brewer and M. Nash, “The Chinese Wall Security Policy”, Proceedings of the 1989 IEEE Symposium on Security and Privacy, 1989, pp. 206-214.
[10] D. Clark and D. Wilson, “A Comparison of Commercial and Military Security Policies”, Proceedings of the 1987 IEEE Symposium on Security and Privacy, 1987, pp. 184-194.
[11] T. H. Hinke, “The Trusted Server Approach to Multilevel Security”, Proceedings of the 5th Annual Computer Security Applications Conference, 1989, pp. 335-341.
[12] D. Galik and B. Tretick, “Fielding Multilevel Security into Command and Control Systems”, Proceedings of the 7th Annual Computer Security Applications Conference, 1991, pp. 202-208.
[13] B. Neugent, “Where We Stand in Multilevel Security (MLS): Requirements, Approaches, Issues, and Lessons Learned”, Proceedings of the 10th Annual Computer Security Applications Conference, 1994, pp. 304-305.
[14] C. E. Irvine et al., “Overview of a High Assurance Architecture for Distributed Multilevel Security”, Proceedings of the 2004 IEEE Workshop on Information Assurance and Security, 2004, pp. 38-45.
[15] S. N. Foley, L. Gong, and X. Quian, “A Security Model of Dynamic Labeling Providing a Tiered Approach to Verification”, Proceedings of the 1996 IEEE Symposium on Security and Privacy, 1996, pp. 142-153.
[16] J.-M. Kang, W. Shin, C.-G. Park, and D.-I. Lee, “Extended BLP Security Model Based on Process Reliability for Secure Linux Kernel”, Proceedings of the Pacific Rim International Symposium on Dependable Computing, 2001.
[17] C. Payne, “Enhanced Security Models for Operating Systems: A Cryptographic Approach”, Proceedings of the 28^{th} Annual International Computer Software and Applications Conference (COMPSAC'04), 2004.
[18] Y. Liu and X. Li, “Lattice Model Based on a New Information Security Function”, Proceedings of the Autonomous Decentralized Systems, 2005, pp. 566-569.
[19] Q. Huang and C. Shen, “A New MLS Mandatory Policy Combining Secrecy and Integrity Implemented in Highly Classified Secure Level OS”, Proceedings of the 2004 7^{th} International Conference on Signal Processing, vol. 3, 2004, pp. 2409-2412.
[20] J. B. D. Joshi, W. G. Aref, A. Ghafoor, E. H. Spafford, “Security Models for Web-based Applications”, Communications of the ACM, vol. 44, no. 2, 2001, pp. 38-44.
[21] S. Kent, “U.S. Security Options for the Internet Protocol”, Internet Engineering Task Force (IETF) rfc 1108, 1991.
[22] R. Housley, “Security Label Framework for the Internet”, Internet Engineering Task Force (IETF) rfc 1457, 1993.
[23] A. Thummel and K. Eckstein, “Design and Implementation of a File Transfer and Web Services Guard Employing Cryptographically Secured XML Security Labels”, Proceedings of the 2006 IEEE Workshop on Information Assurance and Security, 2006, pp. 26-33.
[24] R. Sandhu, E. J. Coyne, H. L. Feinstein, and C. E. Youman, “Role-Based Access Control Models”, IEEE Computer, vol. 29, no. 2, 1996, pp. 38-47.
[25] S. Osborne, “Configuring Role-Based Access Control to Enforce Mandatory and Discretionary Access Control Policies”, ACM Transactions on Information and System Security, vol. 3, no. 2, 2000, pp. 88-106.
[26] D. F. Ferraiolo, R. Sandhu, S. Gavrila, D. R. Kahn, and R. Chandramouli, “Proposed NIST Standard for Role-Based Access Control”, ACM Transactions on Information and System Security, vol. 4, no. 3, 2001, pp. 224-274.
[27] E. Bertino, P. A. Bonatti, and E. Ferrari, “TRBAC: A Temporal Role-Based Access Control Model”, ACM Transactions on Information and System Security, vol. 4, no. 3, 2001, pp. 191-223.
[28] O. Haugene, “Mikroprosessoren”, NKI-forlaget, 2, rev, utgave 1980.

1. Method for securing information in automatic systems, comprising:
assigning an information object with a security label L that includes n≧2 mutually independent non-overlapping security labels Lᵢ, 2≦i≦n, representing linearly independent aspects of confidentiality, integrity and/or availability, and where each security aspect can have k, levels, that a role or a subject is assigned an access label M consisting of n≧2 mutually independent non-overlapping corresponding access labels Mᵢ;
comparing with security label Lᵢ having the same index (i) in order to grant or reject access, that L and M are adapted such that one binary operation between the operands L and M performs n partial tests on the n pairs (Lᵢ, Mᵢ), and that the binary operation between L and M is followed by logical AND-operations or equivalents between the results of the n partial tests.

2. Method according to claim 1, further comprising:
using mutually exclusive read and write roles having respective access labels M_{iR} and M_{iW} to control read and write access to different levels of confidentiality and integrity such that information having low confidentiality can flow to levels with equal or higher confidentiality but not in the other direction, and such that information having high integrity can flow to levels with equal or lower integrity but not in the other direction.

3. Method according to claim 1, further comprising:
representing one or more of the security labels Lᵢ and corresponding access labels Mᵢ as levels by means of arbitrary, monotonously increasing numerical values where each security level corresponds to one numerical value and vice versa, and that the partial tests uses one or more of the operators <, >, ≦ or ≧.

4. Method according to claim 1, wherein one or more of the security labels Lᵢ are maskable bitfields, such that corresponding access masks Mᵢ have the form of access masks, and that the partial tests comprises one or more of the operators bitewise AND, bitwise OR, logical AND or logical OR as well as the negation operator NOT.

5. Method according to claim 4, further comprising:
shifting the security labels Li mᵢ single bits between each of the k, security levels, and that the corresponding access masks Mᵢ mask out a corresponding number of bits.

6. Apparatus for securing information in automatic systems, further comprising:
an information object that is assigned a security label register L consisting of n≧2 mutually independent non-overlapping security label registers Lᵢ, 2≦i≦n, representing linearly independent aspects of confidentiality, integrity and/or availability, and where each security aspect can have kᵢ levels, such that a role or a subject is assigned an access label register M consisting of n≧2 mutually independent non-overlapping corresponding access label registers Mᵢ, adapted to be compared with security label Lᵢ having the same index (i) in order to grant or reject access, that L and M are adapted such that one binary operation between the operands L and M performs n partial tests on the n pairs (Lᵢ, Mᵢ), and that the binary operation between L and M is followed by logical AND-operations or equivalents between the results of the n partial tests.

7. Apparatus according to claim 6, further comprising:
mutually exclusive read and write role devices having respective access label devices M_{iR} and M_{iW} that are used to control read and write access to different levels of confidentiality and integrity such that information having low confidentiality can flow to levels with equal or higher confidentiality but not in the other direction, and such that information having high integrity can flow to levels with equal or lower integrity but not in the other direction.

8. Apparatus according to claim 6, wherein one or more of the security label registers Lᵢ and corresponding access label devices Mᵢ represent levels by means of arbitrary, monotonously increasing numerical values where each security level corresponds to one numerical value and vice versa, and that the partial tests uses one or more of the operators <, >, ≦ or ≧.

9. Apparatus according to claim 6, wherein one or more of the security label registers Lᵢ is a linear collection of units capable of representing logical levels 0 or 1 corresponding to a maskable bitfields, that corresponding access label devices Mᵢ have the form of access masks, and that the partial tests comprises one or more of the operators bitewise AND, bitwise OR, logical AND or logical OR as well as the negation operator NOT.
